(19) United States
(12) Patent Application Publication
(10) Pub. No.: US 2026/0215435 A1
(43) Pub. Date: Jul. 30, 2026

(54) COMPOUND MICROBIAL CONSORTIUM H2 ANTAGONISTIC TO MULTIPLE PATHOGENIC FUNGI OF POTATO, AND APPLICATION AND PREPARATION METHOD THEREOF

(71) Applicant: Institute of Agricultural Resources and Regional Planning, CAAS, Beijing (CN)

(72) Inventors: Ping HE, Beijing (CN); Xiaojing QU, Beijing (CN); Wencheng DING, Beijing (CN); Xinpeng XU, Beijing (CN); Wei ZHOU, Beijing (CN)

(21) Appl. No.: 19/412,618

(22) Filed: Dec. 8, 2025

(30) Foreign Application Priority Data
Jan. 24, 2025 (CN) 2025101190919

(51) Int. Cl. A01N 63/22; A01P 3/00

(52) U.S. Cl. CPC A01N 63/22; A01P 3/00

(57) ABSTRACT

A compound microbial consortium H2 antagonistic to multiple pathogenic fungi of potato is provided, along with an application and a preparation method thereof, all pertaining to the field of biological control. The compound microbial consortium H2 is prepared by mixing Bacillus subtilis, Bacillus atrophaeus, and Bacillus wiedmannii, and has a relatively strong inhibitory effect on Alternaria solani and Alternaria alternata, which are pathogenic fungi of potato early blight; Fusarium solani, Fusarium oxysporum, and Fusarium equiseti, which are pathogenic fungi of wilt/dry rot; and Didymella glomerata, which is a pathogenic fungus of leaf/stem spot, with all the fungal inhibition 10 rates higher than 46%, and with the Alternaria alternata inhibition rate being the highest at 75.97%. H2 is also relatively good at promoting plant growth. Thus, H2 contains high-quality strains for comprehensive prevention and control of potato soil-borne diseases and has promising prospects in field application.

### CROSS REFERENCE OF RELATED APPLICATION

This is a non-provisional application that claims priority to Chinese application number 2025101190919, filing date Jan. 24, 2025, the entire contents of each of which are expressly incorporated herein by reference.

### BACKGROUND OF THE PRESENT INVENTION

### Technical Field

The present invention pertains to the field of biological control. More particularly, the invention relates to a compound microbial consortium H2 antagonistic to multiple pathogenic fungi of potato, and an application and a preparation method of the compound microbial consortium H2.

### Description of Related Art

Potato is suitable as both a staple food and a vegetable. It is the fourth-largest food crop in the world, belongs to the Solanaceae family, and is vulnerable to soil-borne diseases when continuously cropped. Generally, various pathogenic fungi coexist in soil that suffers from continuous cropping obstacles, and when hydrothermal conditions are favorable and a pathogen accumulates to a certain quantity, the corresponding disease occurs. Soil-borne diseases of potato are primarily fungal diseases, with early blight, wilt/dry rot, and leaf/stem spot diseases distributed extensively across the main potato-producing regions of China. Many potato diseases are caused by mixed pathogens. For example, the pathogens of early blight mainly include Alternaria solani and Alternaria alternata, and the pathogens of wilt/dry rot mainly include Fusarium solani, Fusarium equiseti, and Fusarium oxysporum. Leaf/stem spot diseases include early blight, late blight, and anthracnose, all of which cause spotted lesions on the stems/leaves, affect photosynthesis, and tend to lead to large-scale infection, resulting in yield loss Didymella glomerata, which is known as a grape stem blight pathogen, is an important causal agent of leaf/stem spot diseases, can infect nearly a hundred plant species, and is a quarantine plant pathogenic fungus in China. (A Didymella glomerata strain was isolated from the spotted lesions on potato stems for the first time in an experimental plot disclosed herein.) Therefore, obtaining an antagonistic microbial agent that broadly inhibits multiple pathogens and demonstrates stable field efficacy is a pressing issue that needs to be addressed for potato soil-borne diseases.

Bacillus bacteria are widely used in agriculture to promote plant growth and resist diseases, with Bacillus subtilis being the commercial product with the most mature applications. Bacillus atrophaeus is a variant of Bacillus subtilis that is widespread in the natural environment. It shows significant biocontrol potential against various soil-borne diseases and has been widely used in plant disease prevention and control in recent years. Bacillus wiedmannii can degrade sparingly soluble inorganic phosphate in soil, has been reported as capable of inhibiting diseases such as brown root rot, anthracnose, and wilt, and is used mainly for crop growth promotion, with relatively few applications in soil-borne disease suppression of the three strains mentioned above, only Bacillus subtilis has been relatively widely used in the prevention and control of potato diseases, mostly against late blight. There have been no reported instances of Bacillus subtilis, Bacillus atrophaeus, or Bacillus wiedmannii simultaneously inhibiting the pathogenic fungi of potato early blight, wilt/dry rot, and leaf/stem spot diseases, or more particularly Alternaria solani, Alternaria alternata, Fusarium solani, Fusarium oxysporum, Fusarium equiseti, and Didymella glomerata.

Recently, the development of biotechnology has improved the efficiency of obtaining antagonistic microbes. As the synergistic inhibitory effect of a compound microbial consortium is often superior to that of a single strain, the development and application of beneficial microbial communities such as plant growth-promoting rhizobacteria (PGPR) and synthetic microbial communities (SynCom) have gradually received attention. However, stable, broad-spectrum disease-suppressing compound microbial agents are still under exploration. Moreover, the combination of the aforesaid Bacillus subtilis, Bacillus atrophaeus, and Bacillus wiedmannii has not been reported as a compound microbial agent for inhibiting potato soil-borne diseases.

### BRIEF SUMMARY OF THE INVENTION

To solve the technical problems stated above, the present invention provides a compound microbial consortiumH2 that is antagonistic to multiple pathogenic fungi of potato, and an application and a preparation method of the compound microbial consortium H2.

The compound microbial consortiumH2 of the present invention, which is antagonistic to multiple pathogenic fungi of potato, is prepared by mixing Bacillus subtilis, Bacillus atrophaeus, and Bacillus wiedmannii.

The Bacillus subtilis is Bacillus subtilis Bs3, which has been deposited at the China General Microbiological Culture Collection Center (CGMCC), with the deposit address being Building 3, No. 1 Courtyard, Beichen West Road, Chaoyang District, Beijing; the deposit date being Nov. 11, 2024; and the accession number being CGMCC No. 32579.

The Bacillus atrophaeus is Bacillus atrophaeus Ba45, which has been deposited at the China General Microbiological Culture Collection Center, with the deposit address being Building 3, No. 1 Courtyard, Beichen West Road, Chaoyang District, Beijing; the deposit date being Nov. 11, 2024; and the accession number being CGMCC No. 32577.

The Bacillus wiedmannii is Bacillus wiedmannii Bw34, which has been deposited at the China General Microbiological Culture Collection Center, with the deposit address being Building 3, No. 1 Courtyard, Beichen West Road, Chaoyang District, Beijing;

the deposit date being Nov. 11, 2024; and the accession number being CGMCC No. 32580.

Furthermore, the compound microbial consortiumH2 is composed of Bacillus subtilis, Bacillus atrophaeus, and Bacillus wiedmannii in a volume ratio of (0.5-2):(0.5-2):(0.5-1), respectively.

The application of the compound microbial consortiumH2 of the present invention, which is antagonistic to multiple pathogenic fungi of potato, is to use the compound microbial consortiumH2 in preparing a microbial agent that is antagonistic to potato pathogenic fungi.

Furthermore, the potato pathogenic fungi are pathogens of soil-borne diseases.

Furthermore, the potato pathogenic fungi are pathogens of soil-borne diseases, and the pathogens of soil-borne diseases are Alternaria solani, Alternaria alternata, Fusarium solani, Fusarium oxysporum, Fusarium equiseti, and Didymella glomerata.

Furthermore, the compound microbial consortiumH2 has a fungal inhibition rate ranging from 46% to 76% against each of Alternaria solani, Alternaria alternata, Fusarium solani, Fusarium oxysporum, Fusarium equiseti, and Didymella glomerata.

The preparation method of the compound microbial consortiumH2 of the present invention, which is antagonistic to multiple pathogenic fungi of potato, is as follows:

Each of Bacillus subtilis (or more particularly Bacillus subtilis Bs3), Bacillus atrophaeus (or more particularly Bacillus atrophaeus Ba45), and Bacillus wiedmannii (or more particularly Bacillus wiedmannii Bw34) is inoculated into a liquid Luria-Bertani (LB) medium and then incubated by being shaken at 180 rpm until its OD₆₀₀ (i.e., optical density at a wavelength of 600 nanometers) reaches 0.6. The resulting bacterial suspensions are mixed in a predetermined ratio, and the mixture of the bacterial suspensions is inoculated into a liquid LB medium and then incubated by being shaken at 180 rpm until its OD₆₀₀ reaches 1.0, thereby obtaining the compound microbial consortium H2.

Furthermore, the compound microbial consortium H2 has a bacterial count greater than or equal to 8.0×10⁹ cfu/mL.

The present invention has the following advantageous effects:

The present invention provides a compound microbial consortium H2 that can inhibit the pathogenic fungi of multiple soil-borne diseases of potato and promote crop growth. Composed of three antagonistic bacterial strains isolated from continuous potato cropping soil in an extreme environment, the compound microbial consortium H2 is not only antifungal to a relatively high degree, but also conducive to potato growth, performing consistently especially in pot cultivation. The compound microbial consortium H2 has a relatively strong inhibitory effect on such pathogenic fungi of potato early blight as Alternaria solani and Alternaria alternata; on such pathogenic fungi of wilt/dry rot as Fusarium solani, Fusarium oxysporum, and Fusarium equiseti; and on such a pathogenic fungus of leaf/stem spot as Didymella glomerata. The inhibition rates against all the aforementioned pathogenic fungi exceed 46%, with the Alternaria alternata inhibition rate being the highest at 75.97%. Compared with Ba45, which has the highest overall inhibition rate against the pathogenic fungi, H2 exhibits a more consistent and stronger disease suppression effect in a pot cultivation experiment: the disease control efficacy of H2 is 50% higher than that of Ba45, and the plant height corresponding to H2 is 23.5% greater than that corresponding to Ba45. Therefore, H2 contains high-quality strains for comprehensive prevention and control of potato soil-borne diseases and has good prospects in field application.

### BRIEF DESCRIPTION OF THE SEVERAL VIEWS OF THE DRAWINGS

FIG. 1 shows photos of isolated cultures of pathogenic fungi, wherein A1 is a photo of isolated cultures; A2-A4 are photos of Alternaria alternata, Alternaria solani, and Didymella glomerata respectively; B1 is a photo of the diseased plant from which the pathogenic fungi were isolated; and B2-B4 are photos of Fusarium solani, Fusarium oxysporum, and Fusarium equiseti respectively;

FIG. 2 shows a BLAST alignment comparison of pathogenic fungi, wherein the data tables correspond, sequentially from top down, to Alternaria alternata, Alternaria solani, Didymella glomerata, Fusarium solani, Fusarium oxysporum, and Fusarium equiseti;

FIG. 3 shows a BLAST alignment comparison of three antagonistic bacterial strains, wherein the data tables correspond, sequentially from top down, to Bacillus atrophaeus, Bacillus wiedmannii, and Bacillus subtilis;

FIG. 4 shows photos that illustrate the morphologies of three antagonistic bacterial strains after purification, wherein the photos correspond, sequentially from left to right, to Bacillus atrophaeus, Bacillus wiedmannii, and Bacillus subtilis;

FIG. 5 shows photos of cocultures of three antagonistic bacterial strains, wherein the photos correspond, sequentially from left to right, to a streaked coculture and a spread coculture;

FIG. 6 shows photos of a plate confrontation inhibition assay, wherein the photos in the upper row correspond, sequentially from left to right, to Alternaria alternata, Alternaria solani, and Didymella glomerata, and the photos in the lower row correspond, sequentially from left to right, to Fusarium solani, Fusarium oxysporum, and Fusarium equiseti;

FIG. 7 shows a photo of a pot cultivation experiment on disease inhibition by Ba45 and the compound microbial consortium H2;

FIG. 8 shows photos of a pot cultivation experiment on plant growth promotion by Ba45 and the compound microbial consortium H2; and

FIG. 9 shows photos of a field inoculation trial plot for continuous potato cropping treated with the compound microbial consortium H2, wherein the photo on the left shows the growth of healthy potato plants in the full flowering stage, and the photo on the right shows the growth during disease development.

### DETAILED DESCRIPTION OF THE INVENTION

To shed more light on the objectives, technical solutions, and advantages of the following embodiments of the present invention, the spirit of the disclosure of the invention is detailed below. Any person of ordinary skill in the art who understands the disclosed embodiments will be able to change and modify the embodiments using the techniques taught herein, without departing from the spirit or scope of the invention.

The following illustrative embodiments of the present invention and their description serve to expound, but not to limit, the invention.

### Embodiment 1: Isolation and Purification of Pathogenic Fungi

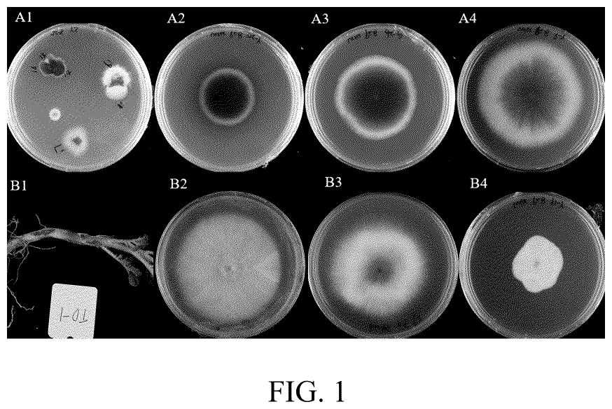

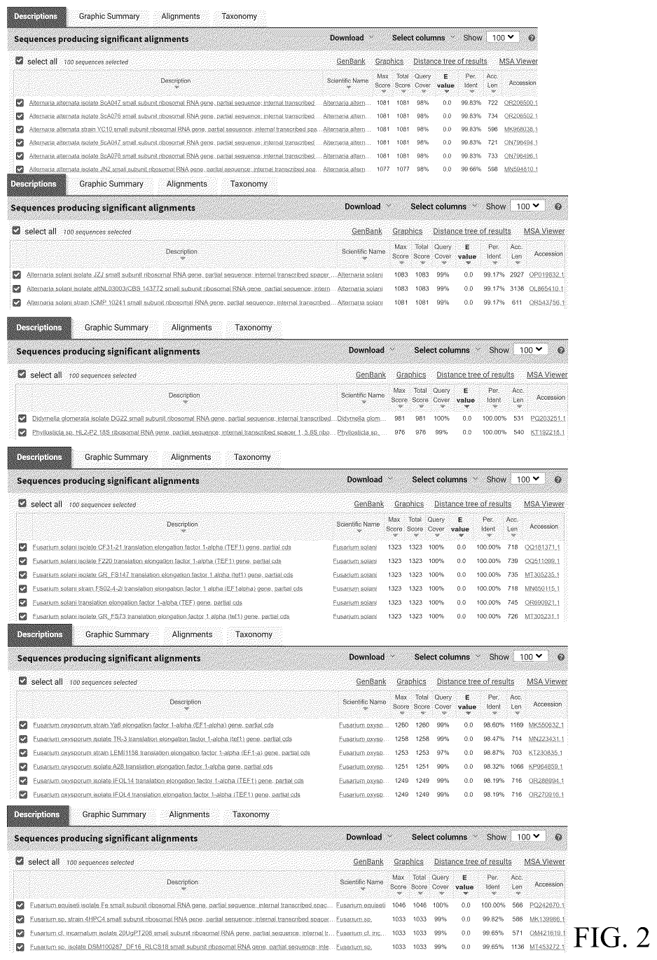

Diseased potato plants were collected from a continuous potato cropping field and were cut into small pieces by plant part. A potato dextrose agar (PDA) culture medium was then used for isolated cultures of pathogenic fungi (see FIG. 1), and the growth status of fungal colonies was observed. The pathogenic fungi were subsequently isolated and purified. Deoxyribonucleic acid (DNA) was extracted from the purified fungi for sequencing, and a comparison against the National Center for Biotechnology Information (NCBI) database was made (see FIG. 2). After that, the fungi were stored in a −80° C. freezer. Some common pathogenic fungi of potato, namely Alternaria solani, Alternaria alternata, Fusarium solani, Fusarium oxysporum, Fusarium equiseti, and Didymella glomerata (which pathogenic fungus was isolated for the first time), were selected for later use.

The aforesaid continuous potato cropping field was located in Wuchuan County, Inner Mongolia Autonomous Region. The soil of the field was calcisol, relatively barren, and low in organic matter content. Moreover, the field was subject to perennial drought and low rainfall.

### Embodiment 2: Isolation and Purification of Bacteria

Continuous potato cropping soil was collected. A 0.5 g sample of the soil was weighed out and put into a sterile Erlenmeyer flask containing 95 mL of LB broth. The flask was then sealed, placed on a shaker, and incubated by being shaken at 220 rpm for 15 min. After standing undisturbed at room temperature for 10 min, the supernatant was collected and subjected to serial dilution to produce 10-3, 10-4, and 10-5 dilutions. 100 μL of each dilution was pipetted and spread onto a nutrient agar (NA) plate, with three replicates prepared for each dilution gradient. After 2 days of incubation in a 37° C. constant-temperature incubator, purification and subsequent subculturing were performed. Single colonies were selected and streaked onto new NA plates to purify the target bacteria, which were then preserved separately in −20° C. and −80° C. freezers for later use.

### Embodiment 3: Screening and Identification of Antagonistic Bacteria

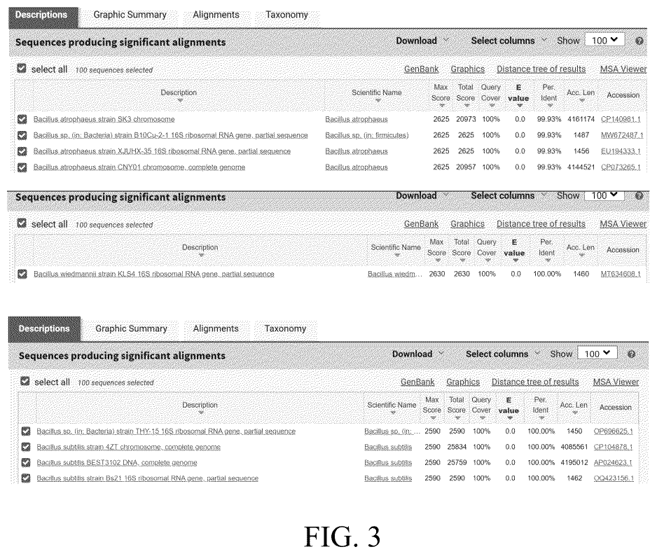

A plate confrontation inhibition assay was conducted to screen for bacterial strains that are inhibitory to all of Alternaria solani, Alternaria alternata, Fusarium solani, Fusarium oxysporum, Fusarium equiseti, and Didymella glomerata. To start with, sterile pipette tips were used to individually transfer colonies of the aforementioned pathogenic fungi onto new PDA plates. Then, the isolated bacterial strains were activated and inoculated onto the plates, with 4 inoculation points per plate and three replicates for each bacterial strain. The Petri dishes were incubated, inverted, in a 30° C. incubator for 48 hours. After that, inhibition zones were observed, and bacteria that produced an inhibition zone were selected for strain identification, which was carried out as follows. DNA was extracted, a polymerase chain reaction (PCR) system was established, and amplification was performed with universal primers, before gel cutting and sequencing. The resulting 16S ribosomal ribonucleic acid (rRNA) gene sequences were compared against the NCBI database (see FIG. 3). The strain with 99.93% homology with Bacillus atrophaeus SK3, Bacillus atrophaeus XJUHX-35, and Bacillus atrophaeus CNY01 in the database was identified as Bacillus atrophaeus and named Ba45 (Bacillus atrophaeus 45). The strain with 100% homology with Bacillus wiedmannii KLS4 in the database was identified as Bacillus wiedmannii and named Bacillus wiedmannii Bw34. The strain with 100% homology with Bacillus subtilis 4ZT, Bacillus subtilis BEST3102, and Bacillus subtilis Bs21 in the database was identified as Bacillus subtilis and named Bacillus subtilis Bs3.

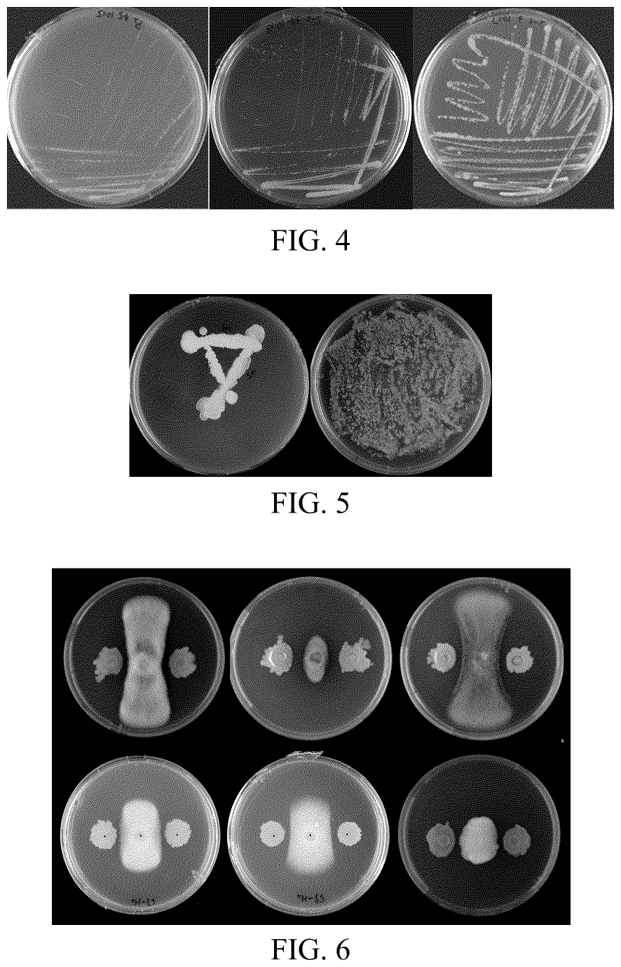

The strain Ba45 (Bacillus atrophaeus 45) selected in this embodiment was milky white on the solid LB medium in an early stage and became creamy yellow, tending toward dark brown, in a later stage. Its colonies had an uneven, opaque, and slightly raised surface and an irregular wavy edge (see the left photo in FIG. 4).

The colony morphology characteristics of the strain Bw34 in this embodiment are as follows: After Bw34 was cultured on a solid LB medium at 37° C. for 2d, its colonies were observed to be milky white, circular, with a smooth surface and an entire margin, viscous, and raised in the center (see the middle photo in FIG. 4).

The Bacillus subtilis in this embodiment is Bacillus subtilis Bs3, whose colony morphology characteristics are as follows: The cells of this Gram-positive bacterium were uniformly colored on the solid LB medium. The colonies had a rough, opaque, and milky white or slightly yellow surface and an entire margin (see the right photo in FIG. 4).

### Embodiment 4: Formulation and Fungal Inhibition Rates of a Compound Microbial Consortium

The inhibition zones of the aforementioned antagonistic bacteria were measured to calculate the fungal inhibition rates, and strains that were antagonistic to all the six aforementioned pathogenic fungi and had relatively high comprehensive fungal inhibition rates were selected to formulate an antagonistic microbial consortium. The selected strains were Bs3, Bw34, and Ba45, and a strain compatibility experiment was conducted to confirm that there was no antagonism among the three strains. After that, the formulation ratio was determined based on the growth rates of the strains, and the volume ratio of Bacillus subtilis, Bacillus atrophaeus, and Bacillus wiedmannii was set at 1:1:1 to yield the compound microbial consortium H2 of the present invention (see FIG. 5). A plate confrontation experiment was then carried out to test the inhibition of the pathogenic fungi by the compound microbial consortium H2 (see FIG. 6), with the fungal inhibition rates calculated (see Table 1).

TABLE 1
Fungal inhibition rates of individual antagonistic
bacterial strains and of the compound microbial
consortium H2 against the pathogenic fungi

| | | Control | Colony diameter | Inhibition |
|---|---|---|---|---|
| | Pathogenic fungus | (cm) | (cm) | rate (%) |
| Bs3 | Alternaria solani | 5.15 | 2.93 | 43.20 |
| | Alternaria alternata | 7.70 | 3.50 | 54.55 |
| | Fusarium solani | 4.57 | 2.62 | 42.70 |
| | Fusarium oxysporum | 4.07 | 2.63 | 35.25 |
| | Fusarium equiseti | 5.60 | 2.58 | 54.02 |
| | Didymella glomerata | 7.60 | 2.55 | 66.45 |
| Bw34 | Alternaria solani | 5.15 | 3.23 | 37.38 |
| | Alternaria alternata | 7.70 | 3.9 | 49.35 |
| | Fusarium solani | 4.40 | 3.27 | 25.76 |
| | Fusarium oxysporum | 4.27 | 4.13 | 3.13 |
| | Fusarium equiseti | 5.60 | 3.25 | 41.96 |
| | Didymella glomerata | 7.80 | 2.95 | 62.18 |
| Ba45 | Alternaria solani | 5.15 | 1.27 | 73.50 |
| | Alternaria alternata | 7.00 | 1.60 | 77.14 |
| | Fusarium solani | 4.33 | 2.33 | 46.15 |
| | Fusarium oxysporum | 4.20 | 2.32 | 44.84 |
| | Fusarium equiseti | 5.60 | 2.55 | 54.46 |
| | Didymella glomerata | 7.70 | 1.60 | 79.22 |
| H2 | Alternaria solani | 5.15 | 1.85 | 64.08 |
| | Alternaria alternata | 7.70 | 1.85 | 75.97 |
| | Fusarium solani | 4.30 | 2.30 | 46.51 |
| | Fusarium oxysporum | 4.50 | 2.33 | 48.15 |
| | Fusarium equiseti | 5.60 | 2.45 | 56.25 |
| | Didymella glomerata | 7.70 | 2.00 | 74.03 |

### Embodiment 5: Preparation of an Inoculum Suspension of the Compound Microbial Consortium

Each of Bs3, Bw34, and Ba45 was inoculated into a liquid LB medium and incubated at 37° C. by being shaken at 180 rpm until the OD value (OD₆₀₀) reached 0.6. The cultures were then mixed in an equal volume ratio, and the mixture was incubated at 37° C. by being shaken at 180 rpm until the OD value (OD₆₀₀) reached 1.0. The mixture was subsequently centrifuged, and the supernatant was removed. Following that, distilled water was added and mixed by vortexing, and centrifugation was performed again. After repeating the foregoing operations, the LB medium was washed away, and water was added to adjust the bacterial count to ≥8.0×10⁹ cfu/mL, thereby producing an inoculum suspension of the compound microbial consortium H2.

### Embodiment 6: Preparation of a Spore Suspension of Mixed Pathogenic Fungi

The mycelium of each of the six aforementioned pathogenic fungi was transferred with an inoculation loop from the corresponding PDA medium into a liquid LB medium and then incubated at 28° C. by being shaken at 200 rpm until the OD value (OD₆₀₀) reached 1.0. The resulting cultures were mixed in an equal volume ratio, and the mixture was shaken for 30 minutes under the same conditions to ensure that the strains were thoroughly mixed to produce a spore suspension of the pathogenic fungus mixture.

### Embodiment 7: Comparison of the Disease Suppression Effects of Antagonistic Bacteria in Pot Cultivation

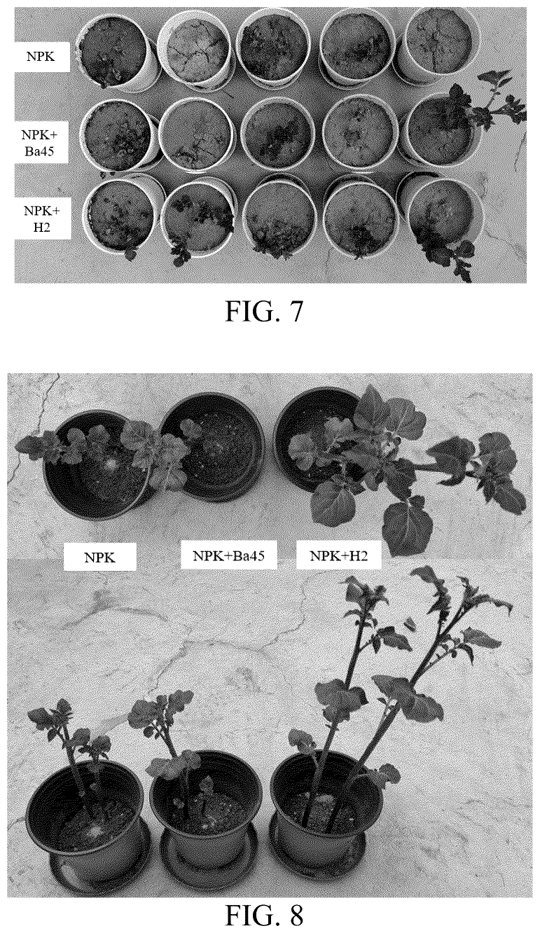

An experiment was performed on Ba45 (which had the highest fungal inhibition rate among the three aforementioned antagonistic bacterial strains) and H2 to compare their disease suppression effects on potted potato (see FIG. 7). Sterile soil was used to plant the potatoes (virus-free seed potatoes), and the treatments included: NPK (applying NPK fertilizer alone), inoculation with Ba45 (NPK+Ba45), and inoculation with H2 (NPK+H2). Each treatment had five replicates, with NPK chemical fertilizer applied in equal amounts across all treatments. The experimental procedure is as follows: After the potatoes emerged, the spore suspension of the aforesaid mixture of six pathogenic fungi was inoculated into the pots at 50 mL per pot. The spore concentration was ≥8.0×10⁹ cfu/mL, and inoculation was performed by root drenching. One day after inoculating the pathogenic fungi, Bacillus atrophaeus Ba45 and H2 were inoculated separately in the same manner. Ten days later, Bacillus atrophaeus Ba45 and H2 were inoculated for a second time while the NPK control received no inoculation. The results (see Table 2) show that, compared with NPK, inoculation with the antagonistic bacteria significantly reduced the disease incidence of the plants, with the control efficacy of H2 reaching 100%. It can also be known from the results that, compared with the single-strain antagonistic bacterium Ba45, the compound microbial consortium H2 was significantly more effect in promoting plant growth and suppressing disease. This suggests that Bacillus subtilis Bs3 and Bacillus wiedmannii Bw34 (i.e., two of the pathogen inhibitors in H2) may have synergistically inhibited the reproduction of Ba45 and thereby lowered its plate-confrontation fungal inhibition rate. In the more complex environment of pot cultivation, where plants actually grew, the synergistic effects among the antagonistic bacterial strains in the compound microbial consortium H2 enhanced the stability of the disease suppression system and the fungal inhibition effect.

TABLE 2
Experiment on disease suppression by antagonistic
bacteria in pot cultivation

| | Number of | Number of | Disease | Control |
|---|---|---|---|---|
| | plotted | diseased | incidence | efficacy |
| Treatment | plants | plants | (%) | (%) |
| NPK | 5 | 2 | 40.0 | — |
| NPK + Ba45 | 5 | 1 | 20.0 | 50.0 |
| NPK + H2 | 5 | 0 | 0 | 100 |

### Embodiment 8: Comparison of the Plant Growth-Promoting Effects of Antagonistic Bacteria in Pot Cultivation

The potato cultivation method in embodiment 7 was used, but the pathogenic fungi were not inoculated after potato emergence; only Ba45 and H2 were inoculated to compare their plant growth-promoting effects (see FIG. 8). The results (see Table 3) show that, with none of the potato plants presenting disease, and in comparison with NPK, the Ba45 inoculation treatment increased the plant height by 35.4% and the stem diameter by 60%, and the H2inoculation treatment increased the plant height by 80.1% and the stem diameter by 140%. It can be known from the above that inoculation with the antagonistic bacteria, in particular H2, produced a plant growth-promoting effect.

TABLE 3
Plant growth-promoting effects of the compound microbial
consortium H2 and of Ba45 in pot cultivation

| | Number of | Average | Average | Number of |
|---|---|---|---|---|
| | plotted | plant | stem | diseased |
| Treatment | plants | height (cm) | diameter (cm) | plants |
| NPK | 3 | 15.55 | 0.5 | 0 |
| NPK + Ba45 | 3 | 21.06 | 0.8 | 0 |
| NPK + H2 | 3 | 28.00 | 1.2 | 0 |

### Embodiment 9: Disease Suppression Effect of the Compound Microbial Consortium H2 in the Field

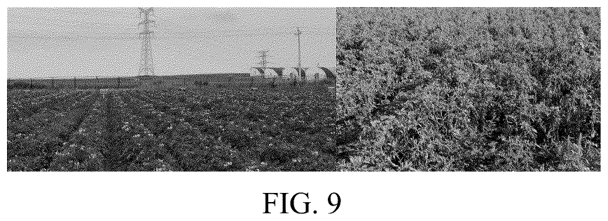

To further verify the stability of the effect of the compound microbial consortium H2 in field applications, a continuous potato cropping experimental field that had experienced recurrent mixed soil-borne diseases in recent years was used in a field experiment to screen for the optimal application method. The experimental treatments included: applying NPK fertilizer alone (NPK), chemicalfertilizer+H2 inoculation (NPKH2), chemical fertilizer+organic matter (NPKM), and chemical fertilizer+organic matter+H2 inoculation (MH2), with each treatment having three replicates (see FIG. 9). In the potato seedling stage, initial flowering stage, and full flowering stage, a compound microbial consortium inoculum suspension prepared according to embodiment 5 was inoculated by root drenching at 100 mL per plant. As the climate conditions of the season were suitable for the reproduction of the early blight pathogens, early blight occurred over a large area of the field. The early blight results (see Table 4) show that, compared with NPK, NPKH2 significantly lowered the disease incidence and the disease index, increasing the potato yield by 74.0%, and that the disease control and yield-increasing effects of NPKH2 were similar to those of NPKM. Compared with NPKH2, H2 inoculation in conjunction with the application of organic matter caused a significant reduction only in disease incidence and made no significant difference in disease index or yield. This indicates that the plant growth-promoting strain Bw34 in the compound microbial consortium H2 was able to exert its plant growth-promoting and yield-increasing effects in the absence of applied organic matter, which suggests that Bw34 is more suitable for use without the addition of organic matter.

TABLE 4
Field application effects of the compound microbial consortium H2

| | | Number of | Disease | | |
|---|---|---|---|---|---|
| | Inoculated | inoculated | incidence | Disease | Yield |
| Treatment | area (m²) | plants | (%) | index | (t/ha) |
| NPK | — | — | 100.0 | 32.96 | 19.2 |
| NPKH2 | 4.86 | 40 | 98.3 | 28.33 | 33.4 |
| NPKM | — | — | 100.0 | 28.89 | 33.0 |
| MH2 | 4.86 | 40 | 96.7 | 28.15 | 33.3 |

The present invention provides a compound microbial consortium H2 that has a relatively strong inhibitory effect on six pathogenic fungi of potato. Subsequent studies may gradually include verification of the compound microbial consortium's inhibitory effect on other pathogenic fungi of potato and the formulation of a blend of the compound microbial consortium and another biocontrol agent. Thus, the invention discloses high-quality strains, and has thereby laid a foundation, for the development and production of microbial agents for widely suppressing the pathogenic fungi of potato soil-borne diseases.

1. A compound microbial consortium H2 antagonistic to multiple pathogenic fungi of potato, characterized in that the compound microbial consortiumH2 is prepared by mixing Bacillus subtilis, Bacillus atrophaeus, and Bacillus wiedmannii, wherein:
the Bacillus subtilis is Bacillus subtilis Bs3, which has been deposited at the China General Microbiological Culture Collection Center (CGMCC), with the deposit address being Building 3, No. 1 Courtyard, Beichen West Road, Chaoyang District, Beijing; the deposit date being Nov. 11, 2024; and the accession number being CGMCC No. 32579;
the Bacillus atrophaeus is Bacillus atrophaeus Ba45, which has been deposited at the China General Microbiological Culture Collection Center, with the deposit address being Building 3, No. 1 Courtyard, Beichen West Road, Chaoyang District, Beijing; the deposit date being Nov. 11, 2024; and the accession number being CGMCC No. 32577; and
the Bacillus wiedmannii is Bacillus wiedmannii Bw34, which has been deposited at the China General Microbiological Culture Collection Center, with the deposit address being Building 3, No. 1 Courtyard, Beichen West Road, Chaoyang District, Beijing; the deposit date being Nov. 11, 2024; and the accession number being CGMCC No. 32580.

2. The compound microbial consortium H2 antagonistic to multiple pathogenic fungi of potato as claimed in claim 1, characterized in that the compound microbial consortiumH2 is composed of the Bacillus subtilis, the Bacillus atrophaeus, and the Bacillus wiedmannii in a volume ratio of (0.5-2):(0.5-2):(0.5-1), respectively.

3. An application of the compound microbial consortium H2 antagonistic to multiple pathogenic fungi of potato as claimed in claim 1, characterized in that the compound microbial consortium H2 is used to prepare a microbial agent antagonistic to potato pathogenic fungi, and the potato pathogenic fungi are Alternaria solani, Alternaria alternata, Fusarium solani, Fusarium oxysporum, Fusarium equiseti, and Didymella glomerata.

4-6. (canceled)

7. A preparation method of the compound microbial consortium H2 antagonistic to multiple pathogenic fungi of potato as claimed in claim 1, characterized in that the preparation method comprises the steps of: inoculating each of the Bacillus subtilis Bs3, the Bacillus atrophaeus Ba45, and the Bacillus wiedmannii Bw34 into a liquid Luria-Bertani (LB) medium; incubating each of the Bacillus subtilis Bs3, the Bacillus atrophaeus Ba45, and the Bacillus wiedmannii Bw34 until an OD₆₀₀ of 0.6 is reached; mixing resulting bacterial suspensions in a predetermined ratio to produce a mixture; inoculating the mixture into a liquid LB medium; and incubating the mixture until an OD₆₀₀ of 1.0 is reached, thereby obtaining the compound microbial consortium H2.

8. The preparation method of claim 7, characterized in that the compound microbial consortium H2 has a bacterial count greater than or equal to 8.0×10⁹ cfu/mL.
